(19) United States
(12) Patent Application Publication
(10) Pub. No.: US 2006/0002569 A1
(43) Pub. Date: Jan. 5, 2006

(54) Loudspeaker systems

(75) Inventor: Laurence Dickie, Brighton (GB)

Correspondence Address: CANTOR COLBURN, LLP, 55 GRIFFIN ROAD SOUTH, BLOOMFIELD, CT, 06002, US

(73) Assignee: Blast Loudspeakers Ltd, Brighton (GB)

(21) Appl. No.: 11/136,296

(22) Filed: May 24, 2005

(30) Foreign Application Priority Data
May 24, 2004 (GB) 0411566.3

(51) Int. Cl. H04R 1/02; H04R 9/06

(52) U.S. Cl. 381/89; 381/335; 381/182

(57) ABSTRACT

A loudspeaker system includes a pair of substantially identical drivers mounted on opposite faces 4 of an enclosure. The drivers are coupled together by a tensioner so as substantially to cancel out reaction forces acting on the enclosure.

This application is entitled to the benefit of, and incorporates by reference essential subject matter disclosed in UK Application No. UK 0411566.3 filed on May 24, 2004.

### BACKGROUND OF THE INVENTION

1. Technical Field

The present invention relates to loudspeaker systems, particularly, but not exclusively, low frequency loudspeaker systems.

2. Background Information

In a moving coil dynamic loudspeaker, the diaphragm is attached to a coil of wire immersed in a magnetic field. When a current passes through the coil the resultant force is transmitted to the diaphragm causing it to accelerate. An equal force acts on the magnet with the result that the magnet, the chassis and any other structure to which the magnet is attached, accelerate in the opposite direction. When excited by an alternating current the cone and chassis exhibit a corresponding cyclic displacement with amplitudes in the inverse ratio of the two masses.

If the chassis is rigidly fixed to an enclosure then it too will be excited by the reaction forces. Although the amplitude of the motion is much smaller than that of the cone, the area of the enclosure and the existence of resonant modes in the structure can give rise to significant acoustic output which interferes with the desired signal from the driver.

An apparently simple solution to this problem would be to decouple the chassis from the enclosure by use of a compliant mount. However it is important that the resonant frequency of the chassis/mount/enclosure system is below that of the range of frequencies handled by the loudspeaker. This would in practice mean providing a very compliant mount. However, a standard flange mounted driver with protruding magnet assembly will exert a considerable moment on the mount, necessitating a stiff support. These two contradictory requirements effectively discount this approach.

A solution to this problem is to support the weight of the magnet with a compliant mount placed to the rear of the driver, perhaps on the rear of the enclosure. However, this is a complicated arrangement.

### DISCLOSURE OF THE INVENTION

The present invention seeks to provide an alternative solution to this problem and from a first aspect provides a loudspeaker system comprising a pair of substantially identical drivers mounted on opposite faces of an enclosure, the drivers being coupled together so as to cancel out reaction forces acting on the enclosure.

Thus in accordance with the invention the reaction forces acting on the respective drivers' chassis are cancelled out, obviating the need for any compliance in the mounting of the driver to the enclosure.

Preferably the drivers are received in apertures in the enclosure walls, each aperture having a seat against which the driver can locate. Preferably, therefore, the coupling means is configured to urge the respective drivers into their respective seats. The coupling means is preferably adjustable to effect the location of the drivers.

Preferably the seats face outwardly so that the drivers are located by pulling them towards one another against their respective seats. Preferably, therefore, the coupling means comprises a tensioner allowing the drivers to be moved towards one another.

In theory, the cancellation of the reaction forces acting on enclosure mean that no compliant mount need be provide between the drivers and the enclosure. However, there may be one or more points through the operating range of the loudspeaker in which the sound produced by the drivers cancels out. More particularly, if the drivers are mounted apart by a half wavelength, then sound of that wavelength will be completely cancelled out. This effect will be progressive, the nearer the wavelength the more cancellation occurring.

In accordance with a preferred feature of the invention, however, this problem is overcome by attenuating the output of one of the drivers for frequencies above a given threshold. Such attenuation is desirable if the shortest wavelength of sound to be reproduced by the cone drivers is less than approximately four times the separation of the drivers.

Preferably the output of the one driver is progressively attenuated with increasing frequency.

This attenuation results in the reaction forces generated by the drivers on the enclosure no longer balancing out. Accordingly the drivers preferably still have a compliant mount to the enclosure. However, because the out of balance reaction forces occur only at a relatively high frequency, a simple compliant mount can be provided. In a simple embodiment therefore, a simple, highly compliant, elastomeric seal may be used. The seal may be of silicone rubber, preferably having a Shore Hardness of approximately thirty (30).

The output of a driver in an enclosure may also be usefully extended to a lower frequency by use of a port connecting the internal volume of the enclosure to the outside. The mass of air in the port reacts with the resilience of the body of air in the enclosure forming a Helmholtz resonator whose resonant frequency is chosen to be below the normal low frequency resonance of the driver in the enclosure.

When air is expelled from the port, the enclosure experiences a small reaction force. It may be therefore concluded that the mounting of the enclosure itself will have some effect on the quality of the Helmholtz resonance, and indeed this effect has been observed in practice. Either solidly mounting the enclosure or completely decoupling it from the earth both result in a high quality Helmholtz resonance. Mounting the enclosure on a lossy support, such as a carpet, diminished this resonance. It is perhaps for this reason that beneficial results have been reported when mounting an enclosure on sharp spikes which pierce the carpet and ensure a solid contact with the floor. Others have insisted that the best way to deal with this problem is to mount the enclosure compliantly, on inflated rubber tubes for instance.

The invention seeks to provide an alternative solution to this problem and from a second broad aspect provides a loudspeaker enclosure comprising a pair of identical ports pointing in opposite directions.

In this way, the reaction forces acting on the enclosure are cancelled out, and the mounting of the enclosure itself ceases to be an issue

The movement of air around the chassis of a loudspeaker driver can also influence the quality of the sound produced by the driver.

Moving coil loudspeakers usually consist of a diaphragm supported at its outer and inner edges by respective compliant suspensions, and attached to a voice coil which is located in the annular gap of a magnet system. The outer edges of both suspensions and the magnet must be securely mounted with respect to each other to ensure the correct alignment of the coil and the magnetic gap at all times.

Usually the task of keeping these various elements aligned is accomplished by the use of a chassis composed of a front outer ring, a rear suspension mounting ring and a rear magnet mounting ring. These three, broadly circular parts are held apart by a number of struts. Low cost chassis are frequently stamped from steel sheet so the result most resembles a dish with large holes removed from the sides to allow the passage of sound from the rear of the cone.

Higher quality drivers, however, employ cast aluminium chassis. For ease of manufacture these still tend to retain struts which constrict the rearward flow of air from the cone. The presence of an acoustically significant chassis can result in colouration of the mid-range frequencies through reflections which interfere with the motion of the diaphragm or, in severe cases, cause Helmholtz cavity resonance.

In accordance with a further aspect of the invention this problem is alleviated by providing a loudspeaker chassis comprising a plurality of struts joining front and rear portions of the chassis, the struts having an aspect ratio of greater than one in a direction facing towards a diaphragm supported by the chassis.

The aspect ratio is the ratio of strut is the ratio of the length of the strut to its width in the given direction. Thus in accordance with this aspect of the invention, the strut is relatively narrow in the direction facing the diaphragm. This virtually eliminates the influence of the chassis on the sound field. Preferably the given direction is a direction radial to the axis of the chassis.

In a preferred embodiment, the aspect ratio varies from about 6:1 at the rear to about 1.5:1 at the front.

Preferably the front edge of each strut is rounded.

A secondary function of the chassis is in the conduction of heat away from the motor system (the magnet/voice coil). In a vented enclosure, where air will be exchanged with that outside, the majority of the heat from the motor can be dissipated within the enclosure. The high aspect ratio design of the struts provides a high surface area from which to dissipate heat.

Preferably the struts taper from their rear end (adjacent the magnet) to their front end (adjacent the diaphragm front suspension. Most preferably the cross sectional area of the strut tapers in a generally parabolic manner, which is known in the art to optimise heat transfer and dissipation from the magnet.

The chassis is not the only component to have a potential effect on the quality of sound produced by the driver. Most moving coil cone drivers comprise a frustoconical diaphragm to which is attached a cylindrical voice coil. This is positioned in the annular gap of the driver magnet. The cone typically has a central hole which is often capped with a dome that excludes dust from the magnetic gap.

If a relatively stiff material is employed for this dome, then as the coil moves in and out of the magnet gap, so the magnetic pole acts like a leaky piston in a cylinder, restricting the motion of the cone assembly. Frequently, therefore, a hole is provided in the centre of the magnet pole to ‘relieve’ this pressure. In fact the air in this hole reacts with that trapped behind the dome to form a Helmholtz resonator. The effect of this resonance is to cause a dip in the frequency response at the front of the cone.

This problem is overcome by a further aspect of this invention, by which there is provided a voice coil assembly comprising a voice coil former and a voice coil wound on the former, wherein the exposed part of the coil former which projects beyond the voice coil has an open area of at least 30%.

With such an arrangement, air noise ceases to be a problem and damping or Helmholtz resonance is effectively eliminated.

The open area can be provided in any number of ways. In a simple embodiment, it can be provided by a number of discrete openings, preferably arranged in rows. Preferably the openings extend over substantially the entire exposed area of the coil former.

In another embodiment, however, the coil former may be made of a foraminate material such as a mesh.

The part of the coil former about which the coil is wound may also be provided with openings, if desired.

At least a part of the former at the end opposite to the voice coil may, in practice be attached, e.g. bonded, to the diaphragm. In such a case, the exposed area of the former will be that area exposed between the voice coil and the attachment to the diaphragm.

### BRIEF DESCRIPTION OF THE DRAWINGS

Some preferred embodiments of the invention will now be described, by way of example only, with reference to the accompanying drawings, in which:

FIG. 1 shows a first embodiment of the invention;

FIG. 2 shows a second embodiment of the invention;

FIG. 3 shows a third embodiment of the invention;

FIG. 4 shows a vertical section along the line A-A of FIG. 3;

FIG. 5 shows a series of horizontal sections through FIG. 4;

FIG. 6 shows a further embodiment of the invention; and

FIG. 7 shows a component of the embodiment of FIG. 6 in greater detail.

### DETAILED DESCRIPTION OF THE INVENTION

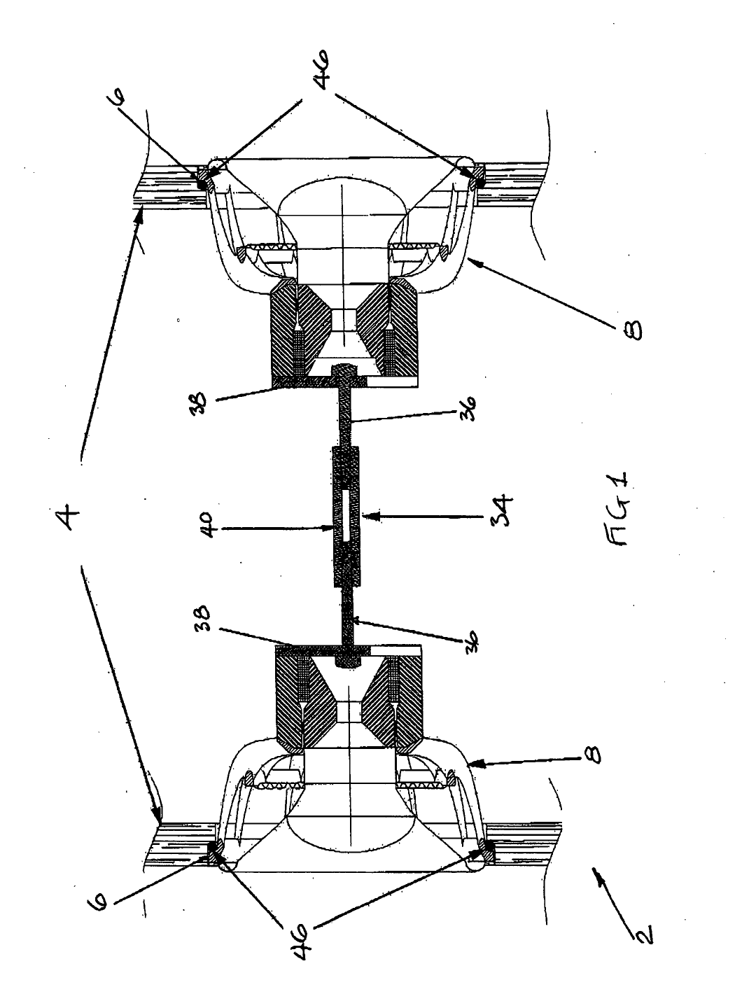

With reference to FIG. 1, a loudspeaker enclosure 2 has opposed walls 4. Two equalized apertures 6 are formed in the walls 4 at co-axial, opposed positions to receive two loudspeaker driver units 8, more particularly 125 mm diameter bass driver units.

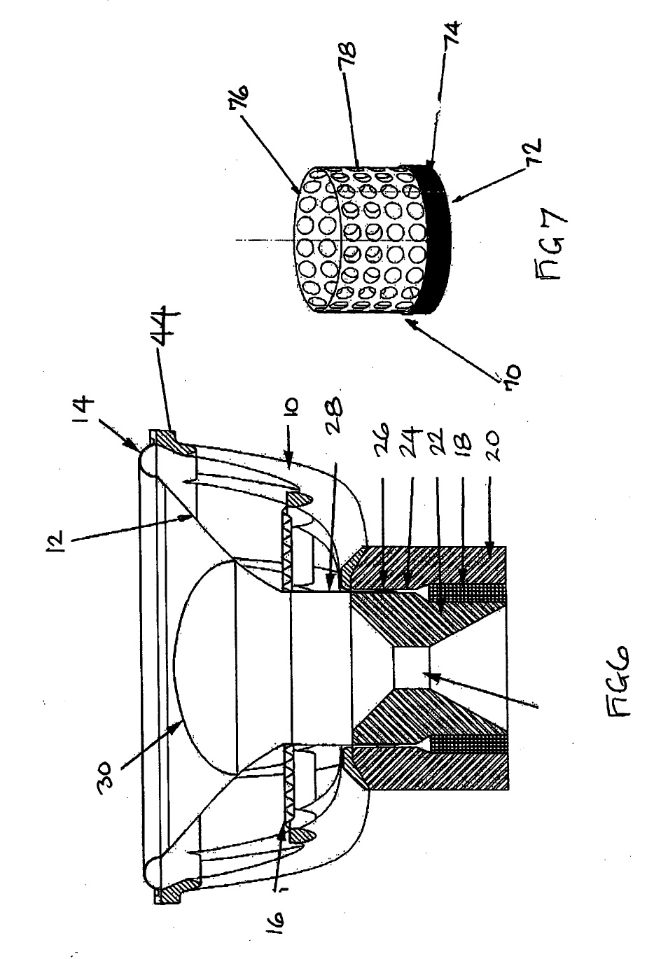

Both driver units 8 are substantially identical, the basic construction of one of the units being shown in greater detail in FIG. 6. From this Figure, it will be seen that the unit 8 comprises a chassis 10 which at supports a cone diaphragm 12 through respective front and rear suspensions 14, 16. It also supports a magnet assembly comprising a magnet 18, and a pair of steel poles 20, 22. The poles 20, 22 define a magnetic gap 24 therebetween which receives a voice coil 26 provided on a coil former 28 which is attached to the lower end of the cone diaphragm. A dome 30 is provided over the inner part of the cone 1 and the steel pole 22 is provided with a vent hole 32.

However, as shown in FIG. 1, the two units 8 are coupled together by a dual thread tensioner 34 which comprises two externally threaded members 36 attached to respective aluminium bars 38 which are bolted to the respective poles 20 of the respective driver units 8. An internally threaded member 40 engages with the externally threaded members 36 such that rotation of the former will either pull the driver units 8 closer together or push them further apart.

The wall apertures 6 have an annular seat 42 for receiving the front flange 44 of the driver chassis 10. An elastomeric O-ring 46, more particularly a silicone rubber o-ring having thirty (30) Shore hardness is received in the seat 42 to compliantly mount the driver unit 8 therein.

It will be seen that to mount the driver units 8 in the enclosure 2, the units 8 are introduced separately into their respective apertures 6 from the outside, the tensioner 34 then assembled and tightened so as to pull the units 8 into the seats 42 with the desired force. The tensioner 34 can then be locked in position.

In use, over at least part of the driver frequency range, the same signal is fed to the respective voice coils 26 of the units 8. This will generate an equal and opposite reaction on the respective chassis 10. However as the chassis 10 are joined through the tensioner 34, these reaction forces will cancel each other, leading to no net reaction oh the enclosure walls.

However, where the shortest wavelength of sound to be reproduced by the drivers is less than approximately four times the separation of the drivers, then it is desirable to attenuate the signal to one of the drivers so as to avoid sound cancellation. This reduces the cancellation of reaction forces on the enclosure walls 4, but the o-ring seals 46 can easily absorb such forces without detriment to sound quality.

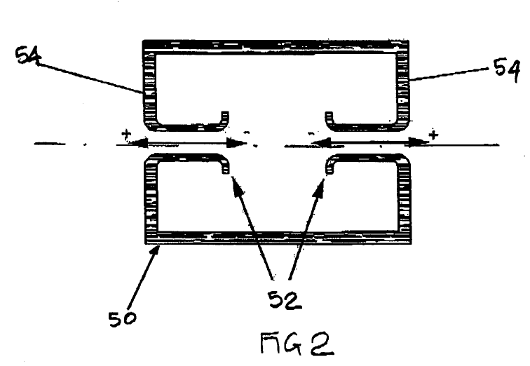

With reference to FIG. 2, an enclosure 50 (which may be the same enclosure as that described above) is provided with opposed, identical ports 52 in opposed walls 54. By positioning ports 52 in this way, the reaction forces on the enclosure 50 due to the expulsion of air through the ports 52 cancel out.

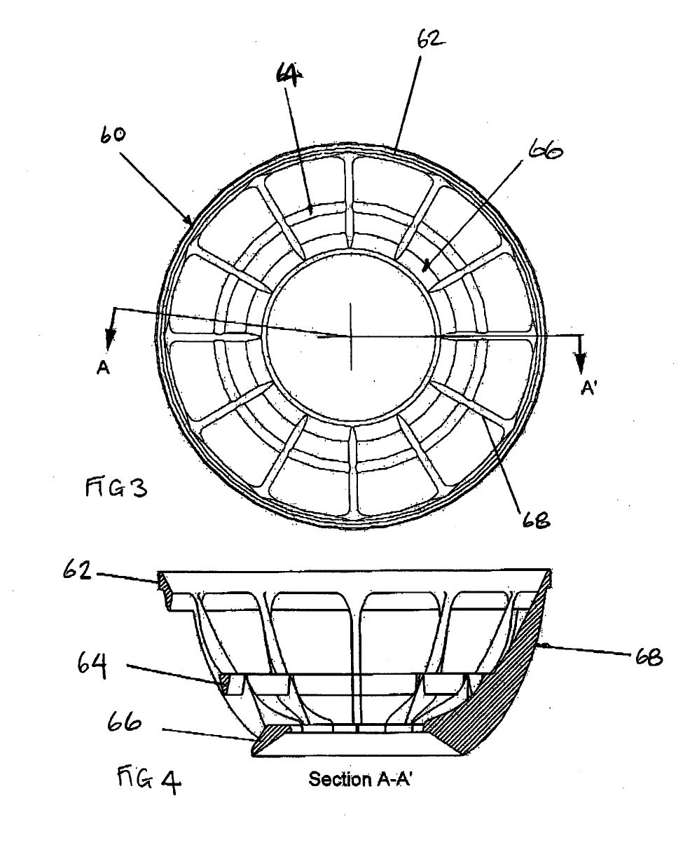

Turning now to FIGS. 3 to 5, these figures show the detail of a chassis 60 suitable for use in the driver unit 8 shown in FIG. 6.

The chassis 60 has a front ring 62, for supporting the front of a cone, an intermediate ring 64 for supporting the cone's rear suspension, and a rear ring 66 for supporting the magnet assembly. The rings 62, 64, 66 are joined by twelve equispaced struts, 68.

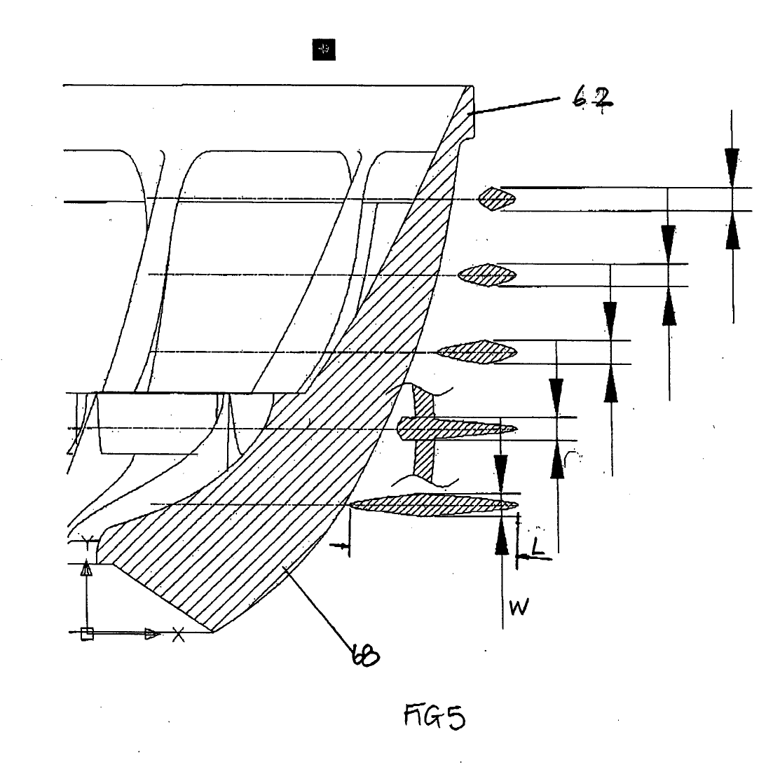

As can be seen from FIG. 5, each strut 68 has an aspect ratio (L/W) in the radial plane which is greater than 1. In this embodiment, the external diameter of the front ring 62 is 155 mm, and the width of each strut 68 is 3 mm, giving an open area of 90%.

The cross sectional area of the strut 68 also increases from the rear ring 66 to the front ring 62 in a parabolic fashion. This provides improved heat dissipation from the magnet assembly mounted at the rear ring 66.

With reference to FIG. 7, this shows a coil former 70 suitable for use in the driver unit shown in FIG. 6.

The former 70 comprises a lower portion 72 onto which is wound a voice coil 74 and an upper portion 76. The upper portion 76 will, in use, be bonded or otherwise attached to the cone 12 of the driver unit 8.

The upper portion 76 is formed with four rows of holes 78 which allow air to pass from the space behind the cone dome 30 thereby substantially preventing air noises.

In this embodiment, the holes create a 41% open area in the upper portion of the former 70.

In practice, the top of the upper portion 76 will be bonded to the diaphragm 12, but this will not appreciably obstruct the holes 78.

It will be appreciated that various modifications can be made to the arrangements described above without departing from the invention. For example while certain advantageous features of the driver units 8 have been described in FIGS. 3, 4, 5 and 7, the invention as described with reference to FIGS. 1 and 2 can employ completely standard driver units. Also, while the driver units are shown in FIG. 1 as being pulled into their seats, it would also be possible to provide an inwardly facing seat and push the units outwardly against these seats.

It will also be understood that the various inventions disclosed can be used together in the same loudspeaker system, or separately.

Although the invention has been shown and described with respect to the detailed embodiments thereof, it will be understood by those skilled in the art that various changes in form and detail thereof may be made without departing from the spirit and scope of the invention.

What is claimed is:

1. A loudspeaker system, comprising a pair of substantially identical drivers mounted on opposite faces of an enclosure, the drivers being coupled together so as substantially to cancel out reaction forces acting on the enclosure.

2. A loudspeaker system as claimed in claim 1 wherein the drivers are received in apertures in the enclosure walls, each aperture having a seat against which the driver locates.

3. A loudspeaker system as claimed in claim 2 wherein a coupling means is configured to urge the respective drivers into their respective seats.

4. A loudspeaker system as claimed in claim 3 wherein the coupling means is adjustable.

5. A loudspeaker system as claimed in claim 2 wherein the seats face outwardly so that the drivers are located by pulling them towards one another against their respective seats.

6. A loudspeaker system as claimed in claim 5 wherein a coupling means comprises a tensioner allowing the drivers to be moved towards one another.

7. A loudspeaker system as claimed in claim 1, further comprising means for attenuating the output of one of the drivers for frequencies above a given threshold.

8. A loudspeaker system as claimed in claim 7 wherein said attenuation is provided if the shortest wavelength of sound to be reproduced by the drivers is less than approximately four times the separation of the drivers.

9. A loudspeaker system as claimed in claim 7 wherein the output of the one driver is progressively attenuated with increasing frequency.

10. A loudspeaker system as claimed in claim 1 wherein the drivers are compliantly mounted to the enclosure.

11. A loudspeaker system as claimed in claim 10 wherein the compliant mount comprises an elastomeric ring.

12. A loudspeaker system as claimed in claim 11 wherein the elastomeric ring is of silicone rubber, having a Shore Hardness of approximately 30.

13. A loudspeaker system as claimed in claim 1 wherein the enclosure further comprises a pair of substantially ports pointing in opposite directions.

14. A loudspeaker enclosure comprising a pair of identical ports pointing in opposite directions.

15. A loudspeaker chassis comprising a plurality of struts joining front and rear portions of the chassis, the struts having an aspect ratio of greater than one in a direction facing radially towards a diaphragm supported by the chassis.

16. A loudspeaker chassis as claimed in claim 15 wherein the aspect ratio varies from about 6:1 at the rear to about 1.5:1 at the front.

17. A loudspeaker chassis as claimed in claim 15 wherein a front edge of each strut is rounded.

18. A loudspeaker chassis as claimed in claim 15 wherein the struts taper from their rear end to their front end.

19. A loudspeaker chassis as claimed in claim 18 wherein a cross sectional area of each strut varies in a generally parabolic manner.

20. A voice coil assembly comprising a voice coil former and a voice coil wound on the coil former, wherein the exposed part of the coil former which projects beyond the voice coil has an open area of at least 30%.

21. A voice coil assembly as claimed in claim 20 wherein the open area is provided by a plurality number of discrete openings.

22. A voice coil assembly as claimed in claim 21 wherein the openings are arranged in rows.

23. A voice coil assembly as claimed in claim 21 wherein the openings extend over substantially the entire exposed area of the coil former.

24. A voice coil assembly as claimed in claim 20 wherein the coil former is made of a foraminate material.

25. A voice coil assembly as claimed in claim 24 wherein the coil former is formed from a mesh.

26. A voice coil assembly as claimed in claim 20 wherein the coil former is attached to a diaphragm and the exposed area is that area exposed between the coil and the diaphragm.

27. A voice coil former for an assembly as claimed in claim 20.
